(19) United States
(12) Patent Application Publication
(10) Pub. No.: US 2004/0163687 A1
(43) Pub. Date: Aug. 26, 2004

(54) Dishwasher

(75) Inventors: Wang-Seok Son, Seoul (KR); Sam-Young Jang, Yongin-City (KR); Tae-Young Jung, Hwasung-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/726,533

(22) Filed: Dec. 4, 2003

(30) Foreign Application Priority Data
Feb. 26, 2003 (KR) 2003-11985

(51) Int. Cl. B08B 3/00

(52) U.S. Cl. 134/58 D; 134/115 R; 134/133; 134/165

(57) ABSTRACT

A dishwasher which move a rack up and down by a simple structure. The rack is rotatably mounted to a frame by a plurality of rotary members and upper and lower hinge shafts. The frame is provided in a cavity to be moved forward and backward. A plurality of extension pieces upwardly extend from both sides of the frame. A stopper is provided on each of the extension pieces. Each of the rotary members is stopped by the stopper so that the rotary member is not forwardly rotated beyond a predetermined distance. A damper is mounted to an outer surface of each lower hinge shaft so that the rack is slowly moved toward the frame during a downward movement of the rack. A handle is provided at an upper portion of the rack so that both ends of the handle are rotatably mounted to both sides of the rack, thus allowing the rack to be easily moved upward.

### CROSS-REFERENCE TO RELATED APPLICATIONS

This application claims the benefit of Korean Patent Application No. 2003-11985, filed Feb. 26, 2003, in the Korean Intellectual Property Office, the disclosure of which is incorporated herein by reference.

### BACKGROUND OF THE INVENTION

1. Field of the Invention

The present invention relates, in general, to dishwashers and, more particularly, to a dishwasher, which is designed such that a rack is mounted in the dishwasher to be moved up and down, thus allowing dishes to be conveniently put in or taken out from the rack.

2. Description of the Related Art

A dishwasher includes a cabinet and a door. The cabinet has a box shape which is opened at a front thereof, and has a cavity therein to receive dishes to be washed. The door is mounted to the front of the cabinet to open or close the cabinet.

Upper and lower racks are installed in the cavity to hold dishes to be washed therein. A water container is installed at a lower portion of the cavity to collect wash water. A circulation pump and a drain pump are connected to predetermined positions of the water container. The upper and lower racks are installed in the cavity in such a way as to be moved forward and backward. Thus, when the upper and lower racks are moved forward, a user puts dishes into the upper and lower racks.

Further, a plurality of spray nozzles are provided in the cavity so that water, fed through a circulation pipe connected to the circulation pump, is sprayed on the upper and lower racks through the spray nozzles, thus washing the dishes held in the racks. A drain pipe is connected to an outlet of the drain pump to discharge wash water to the outside when a washing operation is completed.

Thus, when the circulation pump is operated, water collected in the water container is fed to the spray nozzles through the circulation pipe. While water is sprayed in several directions through the spray nozzles, the dishes held in the upper and lower racks are washed. When the washing operation is completed, the drain pump is operated to discharge wash water through the drain pipe to the outside.

However, the conventional dishwasher has a problem such that the lower rack is provided at the lower portion of the cabinet and the dishes are put into and taken out from the lower rack when the lower rack is pulled out, so a user must bend his and/or her waist to put the dishes in and take the dishes out from the lower rack. Thus, the conventional dishwasher is inconvenient to use and is bad for the body. Further, since relatively large and heavy dishes are put into the lower rack in comparison with the upper rack, it is difficult to put the dishes in and take the dishes out from the lower rack.

In order to solve the problems, Korean Patent Publication No. 1994-10995 discloses a dishwasher which is designed such that a rack thereof is installed in the dishwasher to be moved up and down.

According to the Korean Patent Publication No. 1994-10995, the dishwasher is provided with a motor, a scissor-type frame, and two sets of racks and pinions. That is, the two pinions mounted to ends of the frame are moved along the two racks in opposite directions by an operation of the motor, so that the frame is closed and opened and thereby the rack, held by the frame, is moved up and down. As such, the dishwasher according to the Korean Patent Publication No. 1994-10995 has a complicated structure.

Such a dishwasher has a problem that many elements are required to manufacture the dishwasher in such a way that the rack is moved up and down, and a large space is required to install the elements in the dishwasher.

### SUMMARY OF THE INVENTION

Accordingly, it is an aspect of the present invention to provide a dishwasher that moves a rack up and down by a simple construction.

It is another aspect of the present invention to provide a dishwasher, including a rack that is stably maintained at a position where the rack is moved up, thus allowing dishes to be stably held in the rack.

It is a further aspect of the present invention to provide a dishwasher, which is designed to prevent the rack from rapidly dropping, thus preventing damage to dishes.

Additional and/or other aspects and advantages of the invention will be set forth in part in the description which follows and, in part, will be obvious from the description, or may be learned by practice of the invention.

The foregoing and/or other aspects of the present invention are achieved by providing a dishwasher, including a cabinet having a cavity therein, a frame installed in the cabinet to be moved forward and backward, a rack holding dishes therein, and a plurality of rotary members, each of the rotary members being rotatably mounted at a lower end thereof to the frame and rotatably mounted at an upper end thereof to the rack so that the rack is moved up and down with respect to the frame.

Further, the dishwasher also includes a stopper mounted at a predetermined position of the frame. Each of the rotary members is stopped by the stopper so that the rotary member is not forwardly rotated beyond a predetermined distance.

Each of the rotary members is mounted to a side of the rack by an upper hinge shaft and to a side of the frame by a lower hinge so as to be rotated forward and backward with respect to the frame.

A plurality of extension pieces upwardly extend from both sides of the frame, and the stopper is provided on each of the extension pieces to be inwardly projected from the extension piece.

In an embodiment of the invention, the stopper is provided on each of the extension pieces so that a forward rotation of each of the rotary members is stopped at a position where the rotary member is rotated forward at an angle of 110° from a horizontal position thereof.

A damper is mounted to an outer surface of each of the lower hinge shafts which rotatably mount the rotary members to the frame, so that the rack is slowly moved toward the frame during a downward movement of the rack.

Furthermore, a handle is provided at an upper portion of the rack so that both ends of the handle are rotatably mounted to both sides of the rack, thus allowing the rack to be easily moved upward.

### BRIEF DESCRIPTION OF THE DRAWINGS

These and/or other aspects and advantages of the invention will become apparent and more readily appreciated from the following description of the preferred embodiment, taken in conjunction with the accompanying drawings of which:

FIG. 1 is a perspective view of a dishwasher, according to an embodiment of the present invention, when a lower rack is at its lowest position;

FIG. 2 is a perspective view of the dishwasher, according to an embodiment of the present invention, when the lower rack is at its highest position;

FIG. 3 is a side sectional view of the dishwasher, according to an embodiment of the present invention, when the lower rack is at its lowest position;

FIG. 4 is a side sectional view of the dishwasher, according to an embodiment of the present invention, when the lower rack is moving up or down; and

FIG. 5 is a side sectional view of the dishwasher, according to an embodiment of the present invention, when the lower rack is at its highest position.

### DETAILED DESCRIPTION OF THE PREFERRED EMBODIMENTS

Reference will now be made in detail to the present preferred embodiment of the present invention, examples of which are illustrated in the accompanying drawings, wherein like reference numerals refer to like elements throughout. The embodiments are described below in order to explain the present invention by referring to the figures.

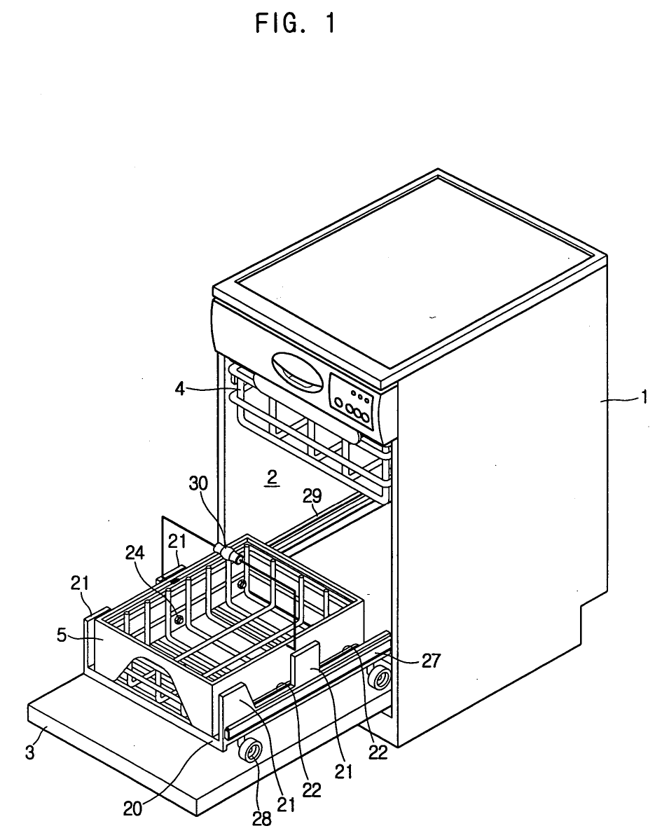

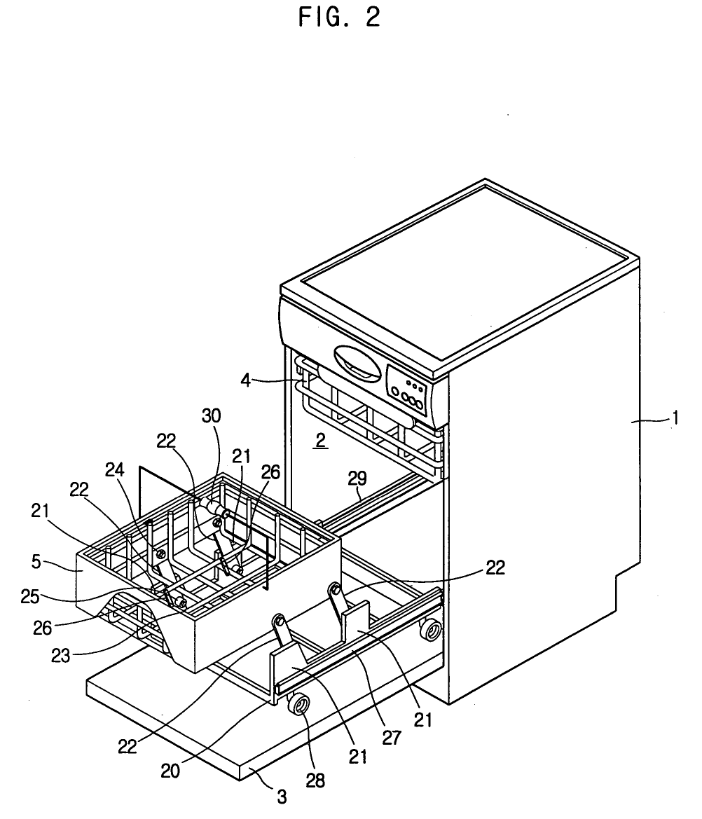

FIG. 1 is a perspective view of a dishwasher, according to an embodiment of the present invention, when a lower rack is at its lowest position. FIG. 2 is a perspective view of the dishwasher, according to an embodiment of the present invention, when the lower rack is at its highest position. As illustrated in the drawings, the dishwasher according to the present invention includes a cabinet 1 and a door 3. The cabinet 1 has a cavity 2 therein to receive dishes to be washed, and is opened at a front thereof. The door 3 is mounted to the front of the cabinet 1 to open or close the cabinet 1.

Upper and lower racks 4 and 5 are provided in the cavity 2. A plurality of spray nozzles (not shown) are included in the cavity 2 to spray wash water on the upper and lower racks 4 and 5. A circulation pump (not shown) which supplies wash water to the spray nozzles and a drain pump (not shown) which discharges wash water to the outside are included at a lower portion of the cavity 2. The upper and lower racks 4 and 5 in the cavity 2 may be moved forward and backward, and hold dishes therein.

A frame 20 is included below the lower rack 5, and is connected to the lower rack 20 by a plurality of rotary members 22 so that the lower rack 20 is moved up and down with respect to the frame 20.

The frame 20 having a rectangular shape includes sliding rails 27, at both sides of the frame, to be moved forward and backward along fixed rails 29 which are included at both sides of the cavity 2. Rollers 28 are mounted to front and rear ends of the frame 20 so as to be easily moved along an inner surface of the door 3 when the door 3 is opened.

Further, extension pieces 21 are integrally provided at front and middle portions of the frame 20 in such a way as to upwardly extend from both sides of the frame 20, thus guiding the rotation of the rotary members 22 so that they are rotated forward and backward.

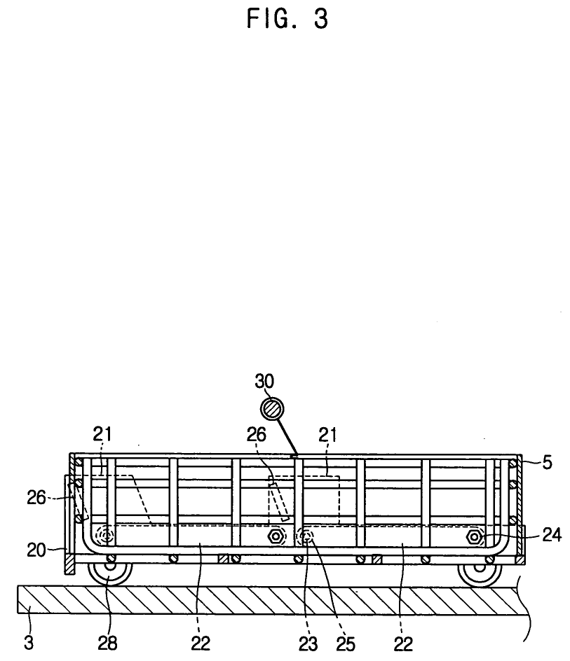

Each of the rotary members 22 is rotatably mounted at a lower end thereof to a lower portion of the extension piece 21 by a lower hinge shaft 23, and is rotatably mounted at an upper end thereof to a side of the lower rack 5 by an upper hinge shaft 24. Thus, when the rotary members 22 are rotated backward, as illustrated in FIG. 3, the lower rack 5 is moved down and comes into close contact with the frame 20. Meanwhile, when the rotary members 22 are rotated forward, as illustrated in FIG. 2, the lower rack 5 is moved up to be spaced apart from the frame 20 by a predetermined height.

A damper 25 is mounted to an outer surface of each of the lower hinge shafts 23 to provide a resistance to rotation of each rotary member 22 only when the lower rack 5 is moved down, thus preventing the lower rack 5 from being rapidly moved down.

Further, a stopper 26 is included on an inner surface of each extension piece 21 to be inwardly projected from the extension piece 21, thus preventing each rotary member 22 from being rotated beyond a predetermined angle. The position of each stopper 26 is determined so that the rotary member 22 is stopped at a position where the rotary member 22 is rotated forward at an angle of 90° to 120° from a horizontal position thereof, thus stably maintaining the lower rack 5 at a raised position. Preferably, the position of each stopper 26 is determined so that the rotary member 22 is stopped at a position where the rotary member 22 is rotated forward at an angle of 110° from the horizontal position thereof, thus allowing the lower rack 5 to be moved as high as possible while allowing dishes to be stably put into the lower rack 5.

Further, a handle 30 is included at an upper portion of the lower rack 5 so that both ends of the handle 30 are rotatably mounted to both sides of the lower rack 5, thus allowing the lower rack 5 to be easily moved upward.

The operation of moving the lower rack up or down by a structure according to the present invention will be described in the following with reference to FIGS. 3 to 5.

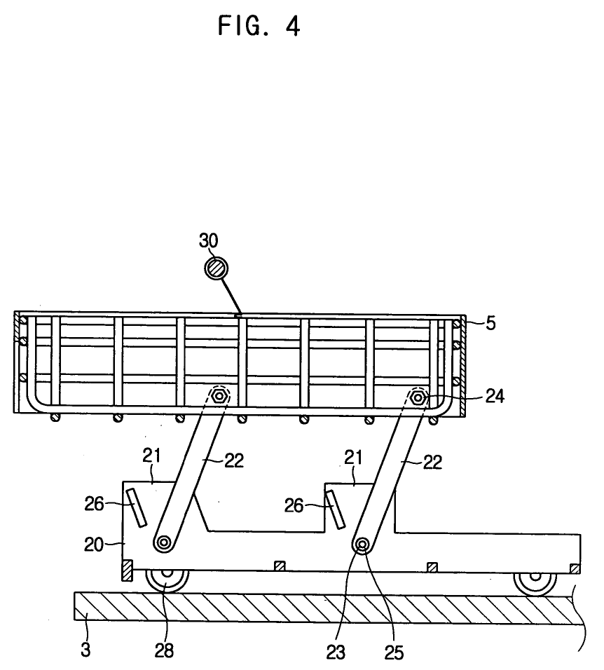

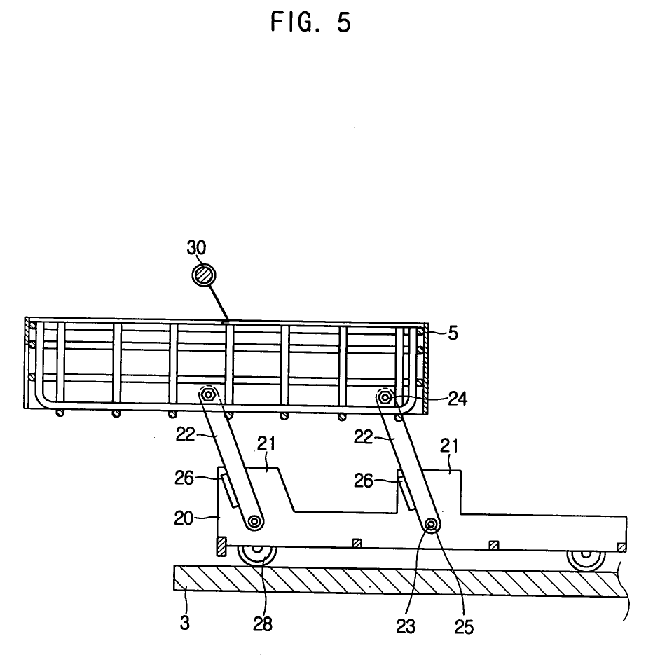

FIG. 3 is a side sectional view of the dishwasher, according to an embodiment of the present invention, when the lower rack is at its lowest position. FIG. 4 is a side sectional view of the dishwasher, according to an embodiment of the present invention, when the lower rack is moving up or down. FIG. 5 is a side sectional view of the dishwasher, according to an embodiment of the present invention, when the lower rack is at its highest position.

As illustrated in FIG. 3, when the lower rack 5 is moved forward along the inner surface of the door 3 to put dishes in or take dishes out from the lower rack 5, the rotary members 22 are horizontally positioned at lower portions of the extension pieces 21. At this time, the lower portion of the lower rack 5 is in close contact with the frame 20, so the lower rack 5 is placed at a lowest position.

In such a state, when a user grasps the handle 30 and pulls the handle 30 forward, as illustrated in FIG. 4, the rotary members 22 are rotated upward so that the lower rack 5 is moved upward with respect to the frame 20. At this time, the damper 25 mounted to each lower hinge shaft 23 does not provide a resistance to rotation of the lower hinge shaft 23, thus allowing each rotary member 22 to be rapidly rotated upward.

When the handle 30 is further pulled forward, as illustrated in FIG. 5, the rotary members 22 are stopped by the stoppers 26 so that the lower rack 5 is placed at a maximally raised position. According to the present invention, in the state where the lower rack 5 is placed at the maximally raised position, a user puts or takes out dishes in or from the lower rack 5, so the user does not have to bend his and/or her waist to put or take out dishes in or from the lower rack 5.

The operation of moving the lower rack 5 downward is carried out in reverse order. That is, when the lower rack 5 is pushed from a position of FIG. 5 to a position of FIG. 4, the lower rack 5 is moved downward due to gravity, thus being placed at a position of FIG. 3. At this time, the damper 25 mounted to each lower hinge shaft 23 provides a resistance to rotation of the lower hinge shaft 23, thus preventing each rotary member 22 from being rapidly moved downward, therefore preventing an impact from being applied to the lower rack 5 and the dishes held in the lower rack 5.

As is apparent from the above description, the present invention provides a dishwasher which is designed to move a lower rack up and down by a simple structure, thus allowing a user to put dishes in and take dishes out from the lower rack without bending his and/or her waist.

Further, the present invention provides a dishwasher which is designed such that a lower rack is stably maintained at a position where the lower rack is moved up, thus allowing dishes to be stably put in or taken out from the lower rack.

Furthermore, the present invention provides a dishwasher which is designed to prevent a lower rack from being rapidly moved downward by dampers mounted to lower hinge shafts, thus preventing the lower rack and dishes held in the lower rack from being damaged due to a user's carelessness.

Although an embodiment of the present invention has been shown and described, it would be appreciated by those skilled in the art that changes may be made in this embodiment without departing from the principles and spirit of the invention, the scope of which is defined in the claims and their equivalents.

What is claimed is:

1. A dishwasher, comprising:
a cabinet having a cavity;
a frame to be moved forward and backward in the cavity;
a rack holding dishes; and
a plurality of rotary members, each rotary member rotatably mounted at a lower end thereof to the frame and at an upper end thereof to the rack so the rack is moved up and down with respect to the frame.

2. The dishwasher according to claim 1, further comprising a stopper mounted at a predetermined position of the frame, wherein the rotary member is stopped by the stopper so the rotary member is not forwardly rotated beyond a predetermined distance.

3. The dishwasher according to claim 2, further comprising:
an upper hinge shaft; and
a lower hinge shaft, wherein the rotary members are mounted to a side of the rack by the upper hinge shaft and to a side of the frame by the lower hinge shaft, respectively, so as to be rotated forward and backward with respect to the frame.

4. The dishwasher according to claim 3, wherein an extension piece upwardly extends from both sides of the frame, and the stopper is included on the extension piece to be inwardly projected from the extension piece.

5. The dishwasher according to claim 4, wherein the stopper is provided on the extension piece so a forward rotation of the rotary member is stopped at a position where the rotary member is rotated forward substantially beyond a right angle from a horizontal position thereof.

6. The dishwasher according to claim 4, wherein the stopper is provided on the extension piece so a forward rotation of the rotary member is stopped at a position where the rotary member is rotated forward at an angle of 110° from a horizontal position thereof.

7. The dishwasher according to claim 3, wherein a damper is mounted to an outer surface of the lower hinge shaft which rotatably mounts the rotary member to the frame, so the rack is slowly moved toward the frame during a downward movement of the rack.

8. The dishwasher according to claim 1, wherein a handle is provided at an upper portion of the rack so that both ends of the handle are rotatably mounted to both sides of the rack, thus allowing the rack to be easily moved upward.

9. A dishwasher, comprising:
a cabinet defining an interior washing cavity;
a frame to move in and out of the washing cavity;
a rotary member that rotatably mounts to the frame at a first end thereof; and
a rack that rotatably mounts to the second end of the rotary member.

10. The dishwasher according to claim 9, wherein the frame is substantially rectangular.

11. The dishwasher according to claim 9, wherein the frame comprises:
a sliding rail; and
a rail fixed to the cavity, wherein the sliding rail moves along the rail fixed to the cavity.

12. The dishwasher according to claim 9, further comprising rollers on front and rear ends of the frame.

13. The dishwasher according to claim 9, further comprising an extension piece integrally connecting to and extending from a front portion of the frame.

14. The dishwasher according to claim 13, further comprising a stopper on an inner surface of and projecting from the extension piece.

15. The dishwasher according to claim 9, further comprising an extension piece integrally connecting to and extending from a middle portion of the frame.

16. The dish washer according to claim 15, further comprising a stopper on an inner surface of and projecting from the extension piece.

17. The dishwasher according to claim 9, further comprising a lower hinge shaft connecting to the frame and the first end of the rotary member.

18. The dishwasher according to claim 9, further comprising a damper on an outer surface of the lower hinge shaft.

19. The dishwasher according to claim 9, further comprising an upper hinge shaft connecting to the rack and the second end of the rotary member.

20. The dishwasher according to claim 9, wherein when the rotary member rotates backward, the rack comes in to close contact with the frame.

21. The dishwasher according to claim 9, wherein when the rotary member rotates forward, the rack moves apart from the frame.

22. The dishwasher according to claim 9, further comprising a handle at an upper portion of the rack.
